(19) United States
(12) Patent Application Publication
(10) Pub. No.: US 2010/0312693 A1
(43) Pub. Date: Dec. 9, 2010

(54) SYSTEMS, PROCESSES AND COMPUTER PROGRAM PRODUCTS FOR THE MANAGEMENT OF INVESTMENT ACCOUNTS

(75) Inventors: Anthony M. Teta, Boston, MA (US); Frank G. O'Neill, Boston, MA (US); Jonnie M. Smith, Boston, MA (US)

Correspondence Address: CHOATE, HALL & STEWART LLP, TWO INTERNATIONAL PLACE, BOSTON, MA, 02110, US

(73) Assignee: JOHN HANCOCK LIFE INSURANCE COMPANY (U.S.A.), Bloomfield Hills, MI (US)

(21) Appl. No.: 12/793,753

(22) Filed: Jun. 4, 2010

Related U.S. Application Data
(60) Provisional application No. 61/184,359, filed on Jun. 5, 2009.

(51) Int. Cl. G06Q 40/00

(52) U.S. Cl. 705/39

(57) ABSTRACT

The present invention relates to systems and processes for administering various automated guaranteed withdrawal features of annuity accounts and other types of investment accounts that include guaranteed withdrawal features. The present invention also encompasses related computer program products.

### PRIORITY CLAIM

This application claims priority to provisional patent application U.S. Ser. No. 61/184,359, filed on Jun. 5, 2009, the entire contents of which is hereby incorporated by reference.

### BACKGROUND

In recent years, variable and fixed annuity accounts have become preferred vehicles for individuals to manage their retirement savings. Many such annuities offer guarantee features, which are designed to protect the account owner from declining markets, and the risk of outliving retirement savings, while still providing the account owner with the ability to capture investment gains in rising markets.

Thus, in addition to offering a stream of income that cannot be outlived, many current annuity products offer “living benefits,” either as part of the product or as optional features available for an added fee that offer exposure to the market's upside while providing guarantees that help protect an account owner's principal investment from market declines and/or provide a minimum future income. In some cases, a combination of these optional benefits may make some annuities a potential rollover vehicle for assets held in other types of qualified accounts such as Individual Retirement Accounts. There are three basic types of living benefits: the guaranteed minimum income benefit (GMIB); guaranteed minimum accumulation benefit (GMAB); and guaranteed minimum withdrawal benefit (GMWB).

In general, a GMIB guarantees that an account owner will receive a minimum future income level regardless of how the market performs. This benefit typically requires the account owner to meet certain criteria, such as owning the contract for a specified number of years before exercising the benefit, and it provides a guarantee that the account owner will receive at least a fixed amount of income on a periodic basis for the rest of his or her life or some set period of time. Some GMIB guarantees offer dollar for dollar withdrawal benefits, which means that an account owner with such a guarantee may withdraw at least a fixed amount each year from his or her account while preserving the value of his or her guarantee. In general, a GMAB ensures that an account owner retains the value of his or her purchase payments regardless of investment performance. At the end of a waiting period, which is typically 10 years but may be another period of time, if the account owner's account value is less than his or her purchase payments, the issuer will add the difference to the account. In general, some GMWBs guarantee a return of the account owner's purchase payments through periodic withdrawals. Such periodic withdrawals are guaranteed until the account owner's principal is returned, even if the account value declines to zero or some other minimum amount. Other GMWBs also, or alternatively, guarantee that the account owner may take withdrawals for life at a certain percentage of their beginning account value (so long as no additional withdrawals are taken).

While the inventions described herein may be used to administer any of these types of benefit guarantees, or any hybrid guarantee that combines features of these standard guarantees, it is particularly useful in administering GMWB guarantees. In the following we therefore use GMWBs to describe the inventions in more detail.

### SUMMARY

The present invention relates to systems and processes for administering various automated guaranteed withdrawal features of annuity accounts and other types of investment accounts that include guaranteed withdrawal features. The present invention also encompasses related computer program products. While this invention is described in the context of guaranteed withdrawal features associated with annuity accounts, it is also applicable to other kinds of investment accounts such as mutual fund accounts, and life insurance policy accounts, that contain guaranteed withdrawal features. This invention is also applicable to a number of types of annuity accounts, including but not limited to variable annuity accounts, fixed annuity accounts, combination variable and fixed annuity accounts, and equity-indexed annuity accounts.

In one aspect, the present invention provides a system comprising one or more components and a computer program product that includes logic stored on a computer readable medium, wherein the logic includes instructions for instructing the one or more components of the system to perform a process for administering withdrawals from an investment account that has a withdrawal option and a guaranteed withdrawal amount that can be withdrawn each account period. The processes include a step of receiving a request from, or on behalf of, an account owner to withdraw automatically, from an investment account, an adjustable amount selected from the group consisting of: (i) the guaranteed withdrawal amount each account period; (ii) a fixed percentage of the guaranteed withdrawal amount each account period; (iii) a variable percentage of the guaranteed withdrawal amount each account period; (iv) the guaranteed withdrawal amount each account period plus an amount before the end of each account period such that the guaranteed withdrawal amount does not decrease at the beginning of the subsequent account period; (v) the guaranteed withdrawal amount each account period plus an additional amount before the end of a calendar year if needed to satisfy a required minimum distribution; (vi) an amount sufficient to satisfy a required minimum distribution over a calendar year plus an additional amount before the end of each account period if needed to fully consume the guaranteed withdrawal amount; and (vii) an amount sufficient to satisfy a required minimum distribution over a calendar year plus an amount at the end of each account period such that the guaranteed withdrawal amount does not decrease at the beginning of the subsequent account period.

In certain embodiments, the process may comprise a step of storing data associated with the account owner's request. In certain embodiments, the process may comprise steps of determining the adjustable amount that will satisfy the account owner's request for the current account period and administering any necessary withdrawals for the current account period. In certain embodiments, the process may comprise steps of determining the adjustable amount that will satisfy the account owner's request for a subsequent account period and administering any necessary withdrawals for the subsequent account period. These steps permit the account owner automatically to receive the adjustable amount that he or she chooses without further intervention on his or her part when that adjustable amount changes.

### BRIEF DESCRIPTION OF THE DRAWING

FIG. 1 is a functional block diagram of the architecture of an exemplary system 100 of the present invention.

### DETAILED DESCRIPTION OF CERTAIN EMBODIMENTS

GMWB guarantees, and certain other types of living benefits, typically have several common features. First, they provide a guarantee that a particular amount of money may be withdrawn periodically for a period of time, and at least that amount of money may be withdrawn regardless of the market performance of the investments in which the account owner's purchase payments are invested. As used herein, an “account owner” is a person(s) who originally entered into the GMWB contract and is therefore entitled to withdraw money from the account. An account owner may be a single individual or two (or more) individuals acting jointly. The benefits to be provided under an account may be measured by the attributes (e.g., age, sex) of the account owner or owners, or by the attributes of another person or persons (i.e., a third party or parties).

### Guaranteed Withdrawal Amount

We use the term “account value” to mean the market value, as calculated by the account issuer, of the investment(s) in which the account owner has chosen to invest his or her purchase payments. Typically the account value is recalculated daily. For example, if the account owner chose to invest her purchase payments in three mutual funds, her account value on any given day would be based on the current market value of the number of shares she owned in each of those mutual funds. In addition to “account value,” many GMWB guarantees utilize a concept that we will call “benefit basis.” The “benefit basis,” which may start off equal to the initial account value, is then guaranteed by the account issuer. In many cases, the account issuer's guarantee may also include a guarantee to increase the benefit basis at a pre-determined rate. For example, the account issuer may guarantee that the benefit basis will grow at the rate of 5% per account period (e.g., per year). The value of the benefit basis may thus diverge from the account value if the market performance of the investments selected by the account owner is other than 5% growth per account period.

The significance of the benefit basis concept is that most GMWBs provide a guarantee that the account owner may withdraw, during each account period, a certain amount of money, which we will call the “guaranteed withdrawal amount,” that is based on the benefit basis. In certain embodiments, the guaranteed withdrawal amount for an account period may be calculated as a fixed percentage of the benefit basis at the beginning of the account period (or end of the previous account period), as adjusted for any increases or decreases of the benefit basis that occur during the account period (e.g., as a result of deposits or unscheduled withdrawals). For example, the guaranteed withdrawal amount for any account period may be 5% of the benefit basis at the beginning of the account period. In other embodiments, however, the guaranteed withdrawal amount for an account period may be calculated as a variable percentage of the benefit basis. As discussed below, such variable percentage may be a percentage that increases or decreases depending on the account owner's age and/or the length of time since the account owner entered into the contract, and/or the investment performance of the contract.

In many GMWBs, each account period is a year, measured by the 12-month period between the anniversary dates of the account owner's decision to enter into the GMWB contract. It is possible, however, for the account period to be some other fixed period of time, such as a 12-month, 6-month, 3-month, 1-month, etc. period measured by different anniversary dates or by calendar months.

Though most GMWBs permit the account owner to withdraw the full guaranteed withdrawal amount in each account period without compromising the protection of the GMWB, many account owners may choose to withdraw an amount less than the guaranteed withdrawal amount over an account period. We will call the amount that an account owner actually chooses to withdraw (each account period or some other period as discussed herein) the “adjustable amount.” The account owner may choose to receive the adjustable amount in one or more periodic installments. For example, without limitation, the account owner may choose to receive weekly, monthly, quarterly, semi-annual, or annual payments within an annual account period.

Typically, the account issuer will recalculate the guaranteed withdrawal amount at the beginning of each account period (or at the end of the previous account period). There are several common GMWB features that may cause the guaranteed withdrawal amount to increase at the beginning of a new account period. Generally, the guaranteed withdrawal amount may increase as a result of an increase in the benefit basis itself and/or an increase in the percentage that is applied to the benefit basis when calculating the guaranteed withdrawal amount.

For example, as discussed above, in certain embodiments the benefit basis may be credited with a certain percentage of growth (e.g., 5%) for each account period. This percentage may be credited either as simple or compound interest. A “bonus” may also be awarded, which may increase the benefit basis by a pre-determined amount or percentage if the account owner engages in certain behavior, such as not taking any withdrawals from the account during one or more account periods. If the guaranteed withdrawal amount is a set percentage of the benefit basis at the beginning of the account period then such an increase in the benefit basis may also cause the guaranteed withdrawal amount to increase. Another mechanism that may affect the benefit base is known as a “step-up,” which means that, at pre-determined intervals, the account issuer will compare the benefit basis with the account value, and if the account value is higher, will increase the benefit basis to be equal to the account value or some percentage of the account value. Again, the guaranteed withdrawal amount will increase if it is a set percentage of the increased value of the benefit basis.

The percentage that is applied to the benefit basis may also increase or decrease. For example, depending on the terms of the contract, as the account owner ages, an increasing or decreasing percentage may be applied to the benefit basis (e.g., 5% until age 65 and 7% thereafter; 5% for the first 10 years and 7% thereafter; 5% until age 80 and 3% thereafter; etc.). In this context we note that when the account is based on the life of a third party (i.e., when the account is not based on the life of an account owner), the increase or decrease in percentage may be tied to the age of the third party. Joint accounts may also provide for increased or decreased percentages when the first account owner (or a third party) reaches a certain age and/or when the second account owner (or a third party) reaches a certain age. It will be appreciated that percentage changes may also be provided with or instead of “step ups” and/or “bonuses.” In general, it is to be understood that a combination of an increase or decrease in benefit basis and the applied percentage may be used in any of the foregoing scenarios. It is also to be understood that the present invention encompasses situations where a GWMB provides for two or more guaranteed amounts that are calculated differently and applied at different points in time (e.g., one guarantee applies until age 70½ and another guarantee thereafter) or based on certain rules or conditions (e.g., the lower of two guaranteed amounts applies or the higher of the two guaranteed amounts applies).

There are also several scenarios in which the guaranteed withdrawal amount may be recalculated at times other than the beginning (or end) of each account period. One such instance is when the account owner makes an additional deposit or purchase payment into his or her account. Such a deposit may increase both the account value and the benefit basis of the account, and may cause the guaranteed withdrawal amount to be recalculated at the time of the deposit (and thereafter applied to the current account period). Another such instance that may cause the recalculation of the guaranteed withdrawal amount occurs when the account owner chooses to make a withdrawal other than, or in addition to, a periodic or scheduled withdrawal within the guaranteed withdrawal amount or a withdrawal administered through a systematic withdrawal program (as discussed below). If such an unscheduled withdrawal is made, the account value will be decreased at least by the amount of the withdrawal, and the benefit basis may also be decreased, depending on whether the amount of the unscheduled withdrawal exceeds the remaining guaranteed withdrawal amount for the remainder of the account period.

Many GMWBs, like many GMIBs, provide account owners with the ability to take systematic withdrawals from their account. These withdrawal features are typically referred to as “systematic withdrawal programs.” Traditionally, these systematic withdrawal programs have permitted account owners to choose the total withdrawal amount they would like to make for each account period (e.g., per year) and the frequency of the payments they would like to receive (most commonly monthly, quarterly, semi-annually, or annually).

In practice, systematic withdrawal programs offered in conjunction with living benefits such as GMWBs (or GMIBs) have been limited, with limited options as to the pattern of withdrawals. Typically, an account owner wishing to obtain regular payments from his or her account could choose an amount up to the guaranteed withdrawal amount for each account period (usually an account year) at the time the systematic withdrawal program began. That amount would be divided by the payment frequency selected by the account owner and then the account issuer would set up, through its computer system, a routine program that would pay such dollar amount to the account owner at the selected payment frequency.

A significant flaw in these prior systematic withdrawal programs is that they continued to pay the same amount, with the same payment frequency, to the account owner, regardless of many types of changes in the account value or in the value of the guaranteed withdrawal amount. As discussed above, various features of the GMWB (or GMIB) or tax requirements with respect to required minimum distributions that must be taken at certain ages, could increase or decrease the dollar amount that the account owner's guarantee would permit him or her to withdraw regularly from the account; however, there was no automated process or system for implementing these changes. Instead, an account owner would have to recognize that his or her aging, or particular changes in his or her account value or guaranteed amount had occurred, and take affirmative steps to request a change in his or her systematic withdrawal program. Also, if an account owner made an additional deposit into his or her account, the guaranteed amount that he or she would be permitted to take could increase immediately but there was no automated system for actually increasing systematic withdrawal payments to the account owner. Instead, the account owner would have to take affirmative steps to learn immediately how the guaranteed amount had increased and to request a change in the systematic payments to that new amount. In addition, the complexity of certain product features of GMIBs and GMWBs made it difficult for an account owner to determine on his or her own the effect of certain types of account changes on the guaranteed amount that he or she would be permitted to withdraw, thus requiring the account owner to guess at the amount allowed to be taken in requesting a new systematic payment amount (or take affirmative steps such as contacting the contract issuer in order to obtain the new guaranteed amount). Such uncertainty could cause significant harm to an account owner who guessed wrong and elected to receive a systematic payment that was more than the amount allowed by his or her guarantee. In certain circumstances, by withdrawing more than permitted by the terms of the guarantee, the account owner could lose all of the protections offered by the guarantee. The inability of prior systematic withdrawal programs to adjust automatically and flexibly to changes in the guaranteed amount that an account owner is permitted to withdraw frequently result in account owners receiving less than they could otherwise obtain.

Particularly because of the age of the population of account owners receiving systematic withdrawals from their retirement savings, a need exists to make systematic withdrawal programs simpler for account owners to use and to make them automatically responsive to changes in account value, or the guaranteed amount that an account owner is permitted to withdraw. The present invention provides systems, processes and computer program products that satisfy this need.

### Systems, Processes and Computer Program Products

The following describes the invention in the context of systems that implement these processes. It is to be understood that the present invention encompasses the processes themselves as implemented via any one of these systems. As discussed in more detail below, the systems comprise one or more components and a computer program product that includes logic stored on a computer readable medium, wherein the logic includes instructions for instructing the one or more components of the system to perform a process of the present invention. It is to be understood that the present invention also encompasses these computer program products. Different system architectures which include components for managing different functions (e.g., data collection, payment, etc.) are also discussed in more detail in a later section.

In general, the system of the present invention administers payments to an investment account owner with a living benefit guarantee. The system administers the payments based on a withdrawal option chosen by the account owner (which encompasses situations where an agent makes, communicates, or implements decisions on behalf of an account owner). It is to be understood that references herein to payments that are made to an account owner encompass situations where payments are instead made to a beneficiary or a trust (e.g., once the account owner has died). In particular, the system automatically adjusts the scheduled payments over time and withdraws an amount in accordance with the chosen withdrawal option. These adjustments are also made in view of the terms of the living benefit guarantee, optionally in conjunction with tax requirements, all the while taking into account subsequent actions by the account owner.

In one aspect, the present invention provides a system that implements a process for administering withdrawals from an investment account that has a withdrawal option and a guaranteed withdrawal amount that can be withdrawn each account period, wherein the process comprises a step of receiving a request from, or on behalf of, an account owner to withdraw automatically, from an investment account, an adjustable amount selected from the group consisting of: (i) the guaranteed withdrawal amount each account period; (ii) a fixed percentage of the guaranteed withdrawal amount each account period; (iii) a variable percentage of the guaranteed withdrawal amount each account period; (iv) the guaranteed withdrawal amount each account period plus an amount before the end of each account period such that the guaranteed withdrawal amount does not decrease at the beginning of the subsequent account period; (v) the guaranteed withdrawal amount each account period plus an additional amount before the end of a calendar year if needed to satisfy a required minimum distribution; (vi) an amount sufficient to satisfy a required minimum distribution over a calendar year plus an additional amount before the end of each account period if needed to fully consume the guaranteed withdrawal amount; and (vii) an amount sufficient to satisfy a required minimum distribution over a calendar year plus an amount at the end of each account period such that the guaranteed withdrawal amount does not decrease at the beginning of the subsequent account period.

In general, it is to be understood that in the context of any one of the embodiments described herein, the present invention encompasses variations of options (i)-(vii) wherein the adjustable amount is modified by subtracting a fixed or variable amount (e.g., $100 less than the adjustable amount calculated under option (i); $100 less than the adjustable amount calculated under option (ii) to be decreased by $10 each account period until it reaches $0; etc.). Additionally or alternatively, a fixed or variable percentage may be applied to the adjustable amount (e.g., 95% of the adjustable amount under option (iv); 80% of the adjustable amount under option (v) to be increased by 1% each account period until it reaches 100%; etc.).

It is also to be understood that in the context of any one of the embodiments described herein, the present invention encompasses variations of options (i)-(vii) wherein the adjustable amount is capped until the account owner reaches a certain age (e.g., based on a maximum distribution allowed under IRS regulations). For example, under IRS regulations a penalty may be applied to annual withdrawals in excess of a certain amount if the account owner has not yet reached age 59½ when the withdrawals commence. Thus, in certain embodiments, a system of the present disclosure might allow the account owner to select one of options (i)-(iv) while placing a temporary cap on the amount withdrawn in a calendar year until the account owner reaches a certain age.

In certain embodiments, the request is based on a selection made from a list of options that includes at least one of options (i)-(vii). In certain embodiments, the list includes 2, 3, 4, 5, 6 or all 7 of options (i)-(vii). In certain embodiments, the list includes at least one of options (i)-(vii) in combination with an option that would provide a fixed withdrawal amount each account period and/or an option that would satisfy the account owner's required minimum distribution (RMD) over a calendar year. In certain embodiments, the list includes options (i), (iv), (v) and (vi). In certain embodiments, the list includes options (i), (iv), (v) and (vi) in combination with an option that would provide a fixed withdrawal amount each account period and/or an option that would satisfy the account owner's required minimum distribution (RMD) over a calendar year. In certain embodiments, the list includes options (i), (iv), (v), (vi) and (vii). In certain embodiments, the list includes options (i), (iv), (v), (vi) and (vii) in combination with an option that would provide a fixed withdrawal amount each account period and/or an option that would satisfy the account owner's required minimum distribution (RMD) over a calendar year. In certain embodiments, the list includes options (i), (ii) and (iii). In certain embodiments, the list includes options (i), (ii) and (iii) in combination with an option that would provide a fixed withdrawal amount each account period and/or an option that would satisfy the account owner's required minimum distribution (RMD) over a calendar year.

In certain embodiments, the process also comprises steps of storing data associated with the account owner's request. In certain embodiments, the process also comprises steps of determining the adjustable amount that will satisfy the account owner's request for the current account period and administering any necessary withdrawals for the current account period. If the request is received after an account period has begun (e.g., 6-months into a one year account period), the system may defer automatic withdrawals until the first full account period. In certain embodiments, payments for the remainder of the current account period may be made in full. Alternatively, payments for the remainder of the current account period may be calculated, and thereafter made, as if the request had been received at the beginning of the account period. For example, if the request would normally require payment of a $1,200 adjustable amount over an annual account period then, instead of paying out $200 per month for the remaining 6-months, the system would pay out $100 per month for the remaining 6-months. This may be preferable if the account owner wishes to make steady withdrawals over multiple account periods (or if the account issuer mandates steady withdrawals). Other payment variations for the initial account period will be recognized by those skilled in the art. In certain embodiments, if the account owner makes withdrawals in the current account period before making the request, then the system will automatically subtract the withdrawn amounts from the adjustable amount to be paid over the remainder of the current account period.

In certain embodiments, the process comprises steps of determining the adjustable amount that will satisfy the account owner's request for a subsequent account period and administering any necessary withdrawals for the subsequent account period. These steps permit the account owner automatically to receive the adjustable amount that he or she chooses without further intervention on his or her part when that adjustable amount changes. In certain embodiments, the determination may be made at the end of the previous account period. In certain embodiments, the determination may be made at the beginning of the subsequent account period. In certain embodiments, the determination may be made at some other time during the account period, e.g., prior to the first withdrawal. As discussed herein, the determination may also be repeated during an account period, e.g., after an account owner makes a deposit or an unscheduled withdrawal.

Although many of the examples provided herein refer to annual account periods that do not correspond to a calendar year or period, the invention is not so limited, and encompasses systems that can automatically determine and administer adjustable amounts determined for account periods other than annual periods, and account periods that correspond to calendar periods. In particular, without limitation, the account period could be a month, a quarter, a six-month period, or a twelve-month period, either corresponding to calendar months, or corresponding to the period of time between account anniversaries or some other pre-determined date. In addition, the present invention provides systems that will administer withdrawal payments to an account owner in a frequency of once or more during each account period. Such payments, while usually made on a monthly, quarterly, semi-annual or annual basis, but may be made on any periodic basis agreed to by the account owner and the account issuer (including an irregular period). In addition, the systems of the invention may administer payments over an account period that are made in equal, increasing or decreasing amounts. For example, the system could make monthly payments over an annual account period but rather than making the payments in twelve equal installments, the system could administer payments in different amounts each month so that the total over the account period equaled the adjustable amount.

In certain embodiments, the systems of the present invention allow the account owner to choose different types of adjustable amounts for pre-determined future account periods. For example, an account owner may wish to elect option (i) but cap the amount withdrawn based on her maximum distribution amount permitted under IRS regulations for withdrawals beginning before age 59½. Alternatively, an account owner may wish to receive the full guaranteed withdrawal amount until age 70½ and thereafter automatically adjust to an amount that would satisfy her required minimum distribution (RMD) under IRS regulations. In such a situation, the account owner might request option (i) until age 70½ followed by an automatic adjustment to the required minimum distribution or to one of options (v), (vi) or (vii). In response to such a request, the system of the present invention would automatically change the way the adjustable amount is calculated once the account owner reaches the pre-determined age and would also adjust payments accordingly. Alternatively, an account owner may wish to receive a fixed amount for a first period of time and then begin receiving an adjustable amount based on one of options (i)-(vii). It is to be understood that the present invention encompasses any permutation or combination of two or more of options (i)-(vii) with or without other options such as a fixed amount, a maximum distribution or a required minimum distribution.

In certain embodiments, the systems of the present invention allow the account owner to defer the automated process by choosing an adjustable amount that will first be paid beginning at the start of a future account period. The system implements such a request without further account owner intervention. In certain embodiments, the present invention further allows the account owner to specify an automatic end date for the automated process. In certain embodiments, the end date could be tied to the account owner's age or to some other pre-condition (e.g., if the account value or benefit basis reaches a particular value or percentage of a baseline value).

In certain embodiments, the systems of the present invention automatically increase or decrease the adjustable amount within an account period in response to deposits or unscheduled withdrawals by the account owner. Thus, when an account owner makes a deposit, the system may increase the adjustable amount accordingly. It is to be understood that this increase in the adjustable amount may be withdrawn by increasing the remaining periodic payments (e.g., in a pro-rated fashion), by paying the account owner a lump sum (e.g., at the end of the account period) or by a combination thereof. When an account owner makes an unscheduled withdrawal, the impact on subsequent payments may depend on the amount withdrawn and the terms of the account issuer's contract. In certain embodiments, any unscheduled withdrawal may cause the system automatically to stop further payments toward the adjustable amount either permanently, or during that account period, or until the account owner notifies the account issuer that he or she would like to have the adjusted amount recalculated in light of the unscheduled withdrawal and to have payments of the adjusted amount resume. In certain embodiments, only an unscheduled withdrawal in excess of the guaranteed withdrawal amount triggers such action. In certain embodiments, an unscheduled withdrawal that results in a withdrawal in excess of the guaranteed withdrawal amount (when combined with any amounts already withdrawn in the account period) triggers such action. In certain embodiments, an unscheduled withdrawal that results in a withdrawal that is less than the guaranteed withdrawal amount (when combined with any amounts already withdrawn in the account period) may cause the system to pro-rate the payments for the remainder of the account period.

Below we discuss certain embodiments of options (i)-(vii) in more detail and provide examples of how each option may operate. It is to be understood that these examples are intended to be non-limiting and merely illustrative of certain embodiments of the invention. In particular, a number of variations on these options are described herein (e.g., embodiments where full payment of the guaranteed withdrawal amount, or percentage thereof, does not occur until the first full account period, etc.).

### Option (i)

If the account owner elects to receive the guaranteed withdrawal amount each account period as the adjustable amount, the system automatically makes payments of the full guaranteed withdrawal amount available on the payment schedule that the account owner has elected. The system automatically recalculates the guaranteed withdrawal amount each time that it is changed as a result either of the features of the GMWB or other living benefit guarantee, or the account owner's actions. The system further automatically recalculates the amounts of the scheduled payments so that the scheduled payments over the account period equal the new guaranteed withdrawal amount.

The operation of one embodiment of option (i) and its benefits are illustrated by the following example in Table 1, which demonstrates only how some typical features of one type of living benefit could be administered. Specifically, this example describes how implementation of one embodiment of option (i) responds to a step up in the benefit basis and a deposit by the account owner. This example assumes that the account owner has an annual account period, beginning on the anniversary date of her GMWB contract. This example also assumes that the account owner has chosen to receive payment in annual installments, rather than monthly, quarterly, semi-annual, or other periodic installments. The operation of one embodiment of option (i) is compared with what would happen in the same situation if the account owner had selected a fixed annual withdrawal amount when purchasing the contract and never intervened to adjust the withdrawal amount.

TABLE 1

| | | Withdrawal | | |
|---|---|---|---|---|
| | | With | Without | |
| Date | Event | option (i) | option (i) | Comments |
| Jun. 15, 2005 | GMWB contract | — | — | Account value and benefit basis are $100,000; by |
| | purchased | | | contract, guaranteed withdrawal amount (GWA) = |
| | | | | 5% of beginning of account period benefit basis |
| | | | | (i.e., $5,000) |
| May 01, 2006 | Scheduled | $5,000 | $5,000 | |
| | withdrawal | | | |
| Jun. 15, 2006 | Contract | — | — | Account value increased to $110,000; by contract |
| | anniversary | | | step up in benefit basis to $110,000 has increased |
| | with a step up | | | GWA to $5,500 |
| May 01, 2007 | Scheduled | $5,500 | $5,000 | Without option (i), the step up is ignored absent |
| | withdrawal | | | account owner intervention. Account owner is not |
| | | | | paid $500 extra of GWA. |
| Jun. 15, 2007 | Contract | — | — | |
| | anniversary | | | |
| | with no step up | | | |
| Sep. 15, 2007 | Additional | — | — | Benefit basis increased to $120,000 so GWA |
| | deposit of | | | increased to $6,000 |
| | $10,000 | | | |
| May 15, 2008 | Scheduled | $6,000 | $5,000 | Without option (i), the deposit is ignored absent |
| | withdrawal | | | account owner intervention. Account owner is not |
| | | | | paid $1,000 extra of GWA. |

### Option (ii)

If the account owner elects to receive a fixed percentage of the guaranteed withdrawal amount each account period as the adjustable amount, the system automatically makes payments of that percentage of the full guaranteed withdrawal amount available on the payment schedule that the account owner has elected. The system automatically recalculates the guaranteed withdrawal amount each time that it is changed as a result either of the features of the GMWB or other living benefit guarantee or the account owner's actions. The system further automatically recalculates the amounts of the scheduled payments so that the scheduled payments over the account period equal the same fixed percentage of the new guaranteed withdrawal amount.

The operation of one embodiment of option (ii), and its benefits are illustrated by the following example in Table 2, which demonstrates only how some typical features of one type of living benefit could be administered. This example assumes that the account owner has an annual account period, beginning on the anniversary date of her GMWB contract. This example also assumes that the account owner has chosen to receive payment at the rate of 90% of the guaranteed withdrawal amount, in annual installments, rather than monthly, quarterly, semi-annual, or other periodic installments. The operation of one embodiment of option (ii) is compared with what would happen in the same situation if the account owner had selected a fixed annual withdrawal amount when purchasing the contract and never intervened to adjust the withdrawal amount.

TABLE 2

| | | Withdrawal | | |
|---|---|---|---|---|
| | | With | Without | |
| Date | Event | option (ii) | option (ii) | Comments |
| Jun. 15, 2005 | GMWB contract | — | — | Account value and benefit basis are $100,000; by |
| | purchased | | | contract, guaranteed withdrawal amount (GWA) = |
| | | | | 5% of beginning of account period benefit basis |
| | | | | (i.e., $5,000) |
| May 01, 2006 | Scheduled | $4,500 | $4,500 | 90% of $5,000 |
| | withdrawal | | | |
| Jun. 15, 2006 | Contract | — | — | Account value increased to $110,000; by contract |
| | anniversary | | | step up in benefit basis to $110,000 has increased |
| | with a step up | | | GWA to $5,500 |
| May 01, 2007 | Scheduled | $4,950 | $4,500 | Without option (i), the step up is ignored absent |
| | withdrawal | | | account owner intervention. Account owner is not |
| | | | | paid $450 extra of GWA. |
| Jun. 15, 2007 | Contract | — | — | |
| | anniversary | | | |
| | with no step up | | | |
| Sep. 15, 2007 | Additional | — | — | Benefit basis increased to $120,000 so GWA |
| | deposit of | | | increased to $6,000 |
| | $10,000 | | | |
| May 15, 2008 | Scheduled | $5,400 | $4,500 | Without option (i), the deposit is ignored absent |
| | withdrawal | | | account owner intervention. Account owner is not |
| | | | | paid $900 extra of GWA. |

Option (iii)

If the account owner elects to receive a variable percentage of the guaranteed withdrawal amount each account period as the adjustable amount, the system automatically makes payments of that changing percentage of the full guaranteed withdrawal amount available on the payment schedule that the account owner has elected. The system automatically recalculates the guaranteed withdrawal amount each time that it is changed as a result either of the features of the GMWB or other living benefit guarantee, or the account owner's actions. The system further automatically recalculates the amounts of the scheduled payments so that the scheduled payments over the account period equal the then-current variable percentage of the new guaranteed withdrawal amount.

The operation of one embodiment of option (iii), and its benefits are illustrated by the following example in Table 3, which demonstrates only how some typical features of one type of living benefit could be administered. This example assumes that the account owner has an annual account period, beginning on the anniversary date of her GMWB contract. This example also assumes that the account owner has chosen to receive payment of her adjustable amount at an initial rate of 50% of the guaranteed withdrawal amount (increasing annually by 10% up to a 100% cap), in annual installments, rather than monthly, quarterly, semi-annual, or other periodic installments. The operation of one embodiment of option (iii) is compared with what would happen in the same situation if the account owner had selected a fixed annual withdrawal amount when purchasing the contract and never intervened to adjust the withdrawal amount.

TABLE 3

| | | Withdrawal | | |
|---|---|---|---|---|
| | | With | Without | |
| Date | Event | option (iii) | option (iii) | Comments |
| Jun. 15, 2005 | GMWB contract | — | — | Account value and benefit basis are $100,000; by |
| | purchased | | | contract, guaranteed withdrawal amount (GWA) = |
| | | | | 5% of beginning of account period benefit basis |
| | | | | (i.e., $5,000) |
| May 01, 2006 | Scheduled | $2,500 | $2,500 | 50% of $5,000 |
| | withdrawal | | | |
| Jun. 15, 2006 | Contract | — | — | Account value increased to $110,000; by contract |
| | anniversary | | | step up in benefit basis to $110,000 has increased |
| | with a step up | | | GWA to $5,500 |
| May 01, 2007 | Scheduled | $3,300 | $2,500 | Without option (i), the step up is ignored absent |
| | withdrawal | | | account owner intervention. Account owner is not |
| | | | | paid $800 extra of GWA. |
| | | | | 60% of $5,500 |
| Jun. 15, 2007 | Contract | — | — | |
| | anniversary | | | |
| | with no step up | | | |
| Sep. 15, 2007 | Additional | — | — | Benefit basis increased to $120,000 so GWA |
| | deposit of | | | increased to $6,000 |
| | $10,000 | | | |
| May 15, 2008 | Scheduled | $4,200 | $2,500 | Without option (i), the deposit is ignored absent |
| | withdrawal | | | account owner intervention. Account owner is not |
| | | | | paid $1,700 extra of GWA. |
| | | | | 70% of $6,000 |

The variable percentage of the guaranteed withdrawal amount that is applied during each account period to determine the adjustable amount may vary in any number of ways. Thus, while Table 3 shows a gradually increasing variable percentage, it is to be understood that the invention is not so limited. In particular, the percentage may vary up and/or down and may even stay fixed across one or more account periods. In addition, percentage changes over a series of account periods may be linear or non-linear.

In certain embodiments, the account owner elects to start with a base percentage that then increases or decreases either by a fixed percentage for each account period (e.g., 50%, 55%, 60%, 65%, etc.), or by an increasing or decreasing percentage for each account period (e.g., 50%, 55%, 65%, 80%, etc.). In certain embodiments, the account owner elects a variable scheme that alternates between two different values (e.g., 60%, 80%, 60%, 80%, etc.). In certain embodiments, the account owner elects a variable scheme that includes two or more consecutive account periods with a fixed percentage (e.g., 50%, 50%, 60%, 60%, 70%, 70%, 80%, 80%, etc.). Those skilled in the art will appreciate that these and other schemes may be combined to produce an unlimited set of variable patterns. In some embodiments, the applicable variable percentage may be calculated as a function of the account period. Any mathematical function may be used for this purpose. For example, in some embodiments, the applicable variable percentage (VP) may be calculated according to the following formula: VP=s*APⁿ+t where AP is the account period (1 for the first account period, 2 for the second account period, etc.) and n, s and t are constants. In certain embodiments n is 1. Another way of selecting the applicable variable percentage is by reference to a publicly-available financial index, such as a consumer price index. In yet other embodiments, the applicable variable percentage may vary as a function of the age of the account owner or a third party. In addition, there may be a cap either at the upper or lower end, or at both the upper and lower end, of the variable percentage that is applied to determine the adjustable amount during any account period. In certain embodiments, the rate of change in the variable percentage from one account period to the next may be capped. In certain embodiments, an upper cap may be applied such that the variable percentage of the guaranteed withdrawal amount that is distributed to the account owner as the adjustable amount does not exceed the guaranteed withdrawal amount (i.e., the upper cap is 100%). In certain embodiments, the system calculates and monitors the difference between the full guaranteed withdrawal amount available and the adjustable amount actually withdrawn each account period. This “deficiency” accumulates over time to create a reserve that we call the “cumulative deficiency.” In certain embodiments, when the account owner elects option (iii), the upper cap may be applied such that the variable percentage of the guaranteed withdrawal amount that is distributed to the account owner as the adjustable amount does not exceed the sum of the guaranteed withdrawal amount and the cumulative deficiency that has accumulated over previous account periods. It will be appreciated that according to this embodiment, the upper cap may exceed 100%.

In certain embodiments, the account period may be less than annual. For example, an account owner may reside in two different locations, each for 6 months of the year, and may have different income needs for the two 6-month periods, e.g., because of additional rent or travel payments in one of the two periods. According to such embodiments, the account owner may choose a 6-month account period with a variable percentage that alternates between two values (e.g., 60% for the 6-month period when income needs are low and 80% for the 6-month period when income needs are high). It will be appreciated that a similar arrangement could also be achieved by electing option (ii) with a 70% fixed percentage for an annual account period and specifying that payments of the adjustable amount are to be made monthly with a lower fraction in the first 6 months and a higher fraction in the second 6 months. In general, it is to be understood that under this embodiment, or any other embodiment described herein, the payments within a given account period can be tailored to any frequency and amount combination as long as the total equals the adjustable amount.

### Option (iv)

If the account owner elects to receive the guaranteed withdrawal amount each account period plus an amount at the end of the account period such that the guaranteed withdrawal amount does not decrease (e.g., increases by less than the full amount or remains unchanged) into the subsequent account period as the adjustable amount, the system automatically makes such payments available on the payment schedule that the account owner has elected. In certain embodiments, the system automatically recalculates the guaranteed withdrawal amount each time that it is changed as a result either of the features of the GMWB or other living benefit guarantee or the account owner's actions. In certain embodiments, the system further automatically recalculates the amounts of the scheduled payments so that the scheduled payments over the account period equal the new guaranteed withdrawal amount. The unique aspect of this option is that, before the end of the account period (e.g., at the end of the account period), the system compares the account owner's account value to his benefit basis. If the account value is higher than the benefit basis, the difference (or a percentage of the difference), which could have been available to “step up” the benefit basis and thereby increase the guaranteed withdrawal amount in the next account period, is paid to the account owner as an additional withdrawal. If the account value is the same as, or lower than, the benefit basis, no additional withdrawal is paid to the account owner. This type of option may be referred to as an “earnings sweep” or “gain stripping.”

The operation of one embodiment of option (iv), and its benefits are illustrated by the following example in Table 4, which demonstrates only how some typical features of one type of living benefit could be administered. This example assumes that the account owner has an annual account period, beginning on the anniversary date of her GMWB contract. This example also assumes that the account owner has chosen to receive payment of her adjustable amount in annual installments, rather than monthly, quarterly, semi-annual, or other periodic installments. The operation of one embodiment of option (iv) is compared with what would happen in the same situation if the account owner had selected a fixed annual withdrawal amount when purchasing the contract and never intervened to adjust the withdrawal amount.

TABLE 4

| | | Withdrawal | | |
|---|---|---|---|---|
| | | With | Without | |
| Date | Event | option (iv) | option (iv) | Comments |
| Jun. 15, 2005 | GMWB contract | — | — | Account value and benefit basis are $100,000; by |
| | purchased | | | contract, guaranteed withdrawal amount (GWA) = |
| | | | | 5% of beginning of account period benefit basis |
| | | | | (i.e., $5,000) |
| May 01, 2006 | Scheduled | $5,000 | $5,000 | |
| | withdrawal | | | |
| Jun. 15, 2006 | Contract | $10,000 | — | Account value increased to $110,000; increase is |
| | anniversary | | | paid to account owner; GWA remains at $5,000 |
| May 01, 2007 | Scheduled | $5,000 | $5,000 | Without option (iv), the increase in account value |
| | withdrawal | | | would have entitled the account owner to a step up in |
| | | | | the benefit basis and an increase in GWA, but |
| | | | | increase in the GWA would not have adjusted the |
| | | | | scheduled payment absent account owner |
| | | | | intervention. |
| Jun. 15, 2007 | Contract | — | — | Account value is equal to benefit basis. No |
| | anniversary | | | additional amount is paid. |

The account owner who elects option (iv) is thus able to receive payments of $10,000 more than the account owner utilizing a prior systematic withdrawal program. While Table 4 illustrates a situation where the account owner chooses to withdraw the full $10,000 “earnings” for the current account period and thereby maintain the guaranteed withdrawal amount constant into the next account period, option (iv) also encompasses situations where the account holder chooses to withdraw less than the full “earnings” (e.g., a percentage or dollar amount less than the full amount). According to such embodiments, the guaranteed withdrawal amount may well increase into the subsequent account period. It is also to be understood that the formula for calculating the guaranteed withdrawal amount may change from one account period to the next (e.g., as a result of an increase or decrease in the percentage applied to the benefit basis) so that even if the account owner withdraws the full “earnings”, the guaranteed withdrawal amount may well still increase into the next account period. Under such a scenario, the present invention encompasses embodiments where the adjustable amount exceeds the full “earnings” in order to maintain the guaranteed withdrawal amount constant into the next account period.

### Option (v)

If an account owner is of an age at which tax minimum distribution requirements apply, that account owner may elect to receive as the adjustable amount the guaranteed withdrawal amount each account period plus an amount before the end of the calendar year if needed to satisfy a required minimum distribution (RMD). It is to be understood that, in certain embodiments, this option could also cover situations where the account owner(s) has died and the beneficiaries need to satisfy an RMD (e.g., where the account benefits are being “stretched” in lieu of being paid in a single sum). If the account owner elects this option, the system automatically makes payments of the guaranteed withdrawal amount on the payment schedule that the account owner has elected. The system automatically recalculates the guaranteed withdrawal amount each time that it is changed as a result either of the features of the GMWB or other living benefit contract, or the account owner's actions. The system further automatically recalculates the amounts of the scheduled payments so that the scheduled payments over the account period equal the new guaranteed withdrawal amount. The unique aspect of this option is that, before the end of the calendar year (e.g., at the end of the calendar year), the system compares the account owner's withdrawals over the course of that calendar year to the applicable required minimum distribution amount, and if the required minimum distribution amount has not yet been met, the additional amount necessary to satisfy that requirement is paid automatically to the account owner. In certain embodiments, the comparison may occur at more than one point during the calendar year, with the amount being paid in more than one installment including a final installment at year end (if needed). If the required minimum distribution has already been satisfied by account withdrawals during that calendar year, no additional payment are made. Most GMWB contracts provide that a payment made to satisfy minimum distribution requirements will not impact the guarantees provided under that contract (i.e., even if the total amount withdrawn for the account period is in excess of the guaranteed withdrawal amount).

The operation of one embodiment of option (v), and its benefits are illustrated by the following example in Table 5, which demonstrates only how some typical features of one type of living benefit could be administered. This example assumes that the account owner is over 70½ years of age and that the required minimum distribution for her age in 2005 is $3,750, and in 2006 is $3,900. This example also assumes that the account owner has an annual account period, beginning on the anniversary date of her GMWB contract. This example also assumes that the account owner has chosen to receive payment of her adjustable amount in annual installments, rather than monthly, quarterly, semi-annual, or other periodic installments. The operation of one embodiment of option (v) is compared with what would happen in the same situation if the account owner had selected a fixed annual withdrawal amount when purchasing the contract and never intervened to adjust the withdrawal amount.

TABLE 5

| | | Withdrawal | | |
|---|---|---|---|---|
| | | With | Without | |
| Date | Event | option (v) | option (v) | Comments |
| Jun. 15, 2005 | GMWB contract | — | — | Account value and benefit basis are $60,000; by |
| | purchased | | | contract, guaranteed withdrawal amount (GWA) = |
| | | | | 5% of beginning of account period benefit basis or |
| | | | | $3,000 |
| Aug. 15, 2005 | Scheduled | $3,000 | $3,000 | |
| | withdrawal | | | |
| Dec. 31, 2005 | End of calendar | $750 | None | Without option (v), the deficiency in RMD is |
| | year | | | ignored absent account owner intervention. Account |
| | | | | owner is not paid $750 extra to satisfy the $3,750 |
| | | | | RMD for 2005. |
| Jun. 15, 2006 | Contract | — | — | Account value increased to $80,000; by contract step |
| | anniversary | | | up in benefit basis to $80,000 has increased GWA to |
| | with a step up | | | $4,000 |
| Aug. 15, 2006 | Scheduled | $4,000 | $3,000 | Without option (v), the step up is ignored absent |
| | withdrawal | | | account owner intervention. Account owner is not |
| | | | | paid $1,000 extra of GWA. |
| Dec. 31, 2006 | End of calendar | None | None | No additional payment is automatically generated |
| | year | | | because the account owner has satisfied the $3,900 |
| | | | | RMD for 2006. |

The account owner who elects option (v) is thus able to satisfy her minimum distribution requirements without taking any additional action. The computerized system automatically determines whether her withdrawals over the course of the calendar year satisfy those requirements, and makes any necessary payments to satisfy those requirements before the end of the calendar year. The account owner utilizing a prior systematic withdrawal program in this example would have had to take action both in 2005 and 2006 to calculate her required minimum distribution amount, determine if it had been satisfied by her withdrawals during that calendar year, and since it had not, take action to request an additional payment from the account issuer.

### Option (vi)

Option (vi) is similar to option (v) in that it is designed to ensure that, if an account owner is of an age at which tax minimum distribution requirements apply, that account owner will satisfy those requirements without further intervention on his or her part. As with option (v), is to be understood that, in certain embodiments, this option could also cover situations where the account owner(s) has died and the beneficiaries need to satisfy an RMD (e.g., where the account benefits are being “stretched” in lieu of being paid in a single sum). Under option (vi), an account owner may elect to receive the adjustable amount in the form of an amount sufficient to satisfy a required minimum distribution over a calendar year plus an additional amount before the end of each account period if needed to fully consume the guaranteed withdrawal amount. As with any payment of the adjustable amount, the amount paid to satisfy the required minimum distribution over a calendar year may be paid as periodic payments. Since the account period and calendar year may be different, it will be appreciated that periodic payments for the same calendar year may occur in two consecutive account periods.

If the account owner elects this option, the system automatically makes payments of the required minimum distribution amount for the given calendar year on the payment schedule that the account owner has elected. Before the end of each account period, the system then compares the amount that has been paid over the past account period to the guaranteed withdrawal amount for that account period. If the amount paid is less than the guaranteed withdrawal amount then the account owner is paid the difference (e.g., as a lump sum before the end of the account period). If the guaranteed withdrawal amount changed over the account period as a result either of the features of the GMWB or other living benefit contract, or the account owner's actions, the system automatically takes those changes into account to ensure that the guaranteed withdrawal amount is paid in full. For each new calendar year, the system further automatically recalculates the amounts of the scheduled payments necessary to satisfy the required minimum distribution for that calendar year. Most GMWB contracts provide that a payment made to satisfy minimum distribution requirements will not impact the guarantees provided under that contract (i.e., even if the total adjustable amount for the account period is in excess of the guaranteed withdrawal amount).

The operation of one embodiment of option (vi), and its benefits are illustrated by the following example in Table 6, which demonstrates only how some typical features of one type of living benefit could be administered. This example assumes that the account owner is over 70½ years of age and that the required minimum distribution for her age in 2005 is $3,750, in 2006 is $3,900, and in 2007 is $4,000. This example also assumes that the account owner has an annual account period, beginning on the anniversary date of her GMWB contract. This example also assumes that the account owner has chosen to receive payment of her adjustable amount in quarterly installments, rather than monthly, semi-annual, annual, or other periodic installments. The operation of one embodiment of option (vi) is compared with what would happen in the same situation if the account owner had selected an option that automatically paid the RMD on a quarterly basis and never intervened to adjust the withdrawal amount.

TABLE 6

| | | Withdrawal | | |
|---|---|---|---|---|
| | | With | Without | |
| Date | Event | option (vi) | option (vi) | Comments |
| Jun. 15, 2005 | GMWB contract | — | — | Account value and benefit basis are $60,000; by |
| | purchased | | | contract, guaranteed withdrawal amount (GWA) = |
| | | | | 5% of beginning of account period benefit basis |
| | | | | (i.e., $3,000) |
| Jun. 31, 2005 | Scheduled | $1,250 | $1,250 | RMD for 2005 is $3,750. There are three quarterly |
| | withdrawal | | | payment dates left in the calendar year to satisfy |
| | | | | requirement. $3,750/3 = $1,250 |
| Sep. 30, 2005 | Scheduled | $1,250 | $1,250 | |
| | withdrawal | | | |
| Dec. 31, 2005 | Scheduled | $1,250 | $1,250 | RMD for 2005 has been satisfied. |
| | withdrawal & | | | |
| | End of calendar | | | |
| | year | | | |
| May. 31, 2006 | Scheduled | $975 | $975 | RMD for 2006 is $3,900. There are four quarterly |
| | withdrawal | | | payment dates left in the calendar year to satisfy |
| | | | | requirement. $3,900/4 = $975 |
| Jun. 15, 2006 | Contract | — | — | GWA for this account period was $3,000. |
| | anniversary | | | Withdrawals for this account period were $4,725. |
| | | | | No additional payment is made. |
| | | | | Account value increased to $80,000; by contract step |
| | | | | up in benefit basis to $80,000 has increased GWA to |
| | | | | $4,000 |
| Jun. 31, 2006 | Scheduled | $975 | $975 | |
| | withdrawal | | | |
| Sep. 30, 2006 | Scheduled | $975 | $975 | |
| | withdrawal | | | |
| Dec. 31, 2006 | Scheduled | $975 | $975 | RMD for 2006 has been satisfied. |
| | withdrawal & | | | |
| | End of calendar | | | |
| | year | | | |
| May, 31, 2007 | Scheduled | $1,000 | $1,000 | RMD for 2007 is $4,000. There are four quarterly |
| | withdrawal | | | payment dates left in the calendar year to satisfy |
| | | | | requirement. $4,000/4 = $1,000 |
| Jun. 15, 2007 | Contract | $75 | — | GWA for this account period was $4,000. |
| | anniversary | | | Withdrawals for this account period were $3,925, |
| | | | | $75 less than GWA. The difference is paid before |
| | | | | the end of the account period. |

The account owner who elects option (vi) is thus able to satisfy her minimum distribution requirements, and still ensure that she receives payment of her full guaranteed withdrawal amount without taking any additional action. The system automatically determines whether her required minimum distribution payments over the span of an account period fully consume the guaranteed withdrawal amount, and makes any necessary payments to provide full benefits to the account owner before the end of each account period.

Option (vii)

As an alternative to option (vi), the account owner may elect to receive as the adjustable amount an amount sufficient to satisfy a required minimum distribution (RMD) over a calendar year plus an amount at the end of each account period such that the guaranteed withdrawal amount does not decrease (e.g., increases by less than the full amount or remains unchanged) into the subsequent account period. As with any payment of the adjustable amount, the amount paid to satisfy the required minimum distribution over a calendar year may be paid as periodic payments. Since the account period and calendar year may be different, it will be appreciated that periodic payments for the same calendar year may occur in two consecutive account periods.

If the account owner elects this option, the system automatically makes payments of the required minimum distribution amount for the given calendar year on the payment schedule that the account owner has elected. Before the end of the account period (e.g., at the end of the account period), the system compares the account owner's account value to his benefit basis. If the account value is higher than the benefit basis, the difference (or a percentage of the difference), which could have been available to “step up” the benefit basis and thereby increase the guaranteed withdrawal amount in the next account period, is paid to the account owner as an additional withdrawal. If the account value is the same as, or lower than, the benefit basis, no additional withdrawal is paid to the account owner. This type of option may be referred to as an “earnings sweep” or “gain stripping.”

The operation of one embodiment of option (vii), and its benefits are illustrated by the following example in Table 7, which demonstrates only how some typical features of one type of living benefit could be administered. This example assumes that the account owner has an annual account period, beginning on the anniversary date of her GMWB contract. This example also assumes that the account owner has chosen to receive payment of her adjustable amount in quarterly installments, rather than monthly, semi-annual, annual or other periodic installments. The operation of one embodiment of option (vii) is compared with what would happen in the same situation if the account owner had elected to receive the RMD as the withdrawal amount and never intervened to adjust the withdrawal amount.

TABLE 7

| | | Withdrawal | | |
|---|---|---|---|---|
| | | With | Without | |
| Date | Event | option (vii) | option (vii) | Comments |
| Jun. 15, 2005 | GMWB contract | — | — | Account value and benefit basis are $60,000; by |
| | purchased | | | contract, guaranteed withdrawal amount (GWA) = |
| | | | | 5% of beginning of account period benefit basis |
| | | | | (i.e., $3,000) |
| Jun. 31, 2005 | Scheduled | $1,250 | $1,250 | RMD for 2005 is $3,750. There are three quarterly |
| | withdrawal | | | payment dates left in the calendar year to satisfy |
| | | | | requirement. $3,750/3 = $1,250 |
| Sep. 30, 2005 | Scheduled | $1,250 | $1,250 | |
| | withdrawal | | | |
| Dec. 31, 2005 | Scheduled | $1,250 | $1,250 | RMD for 2005 has been satisfied. |
| | withdrawal & | | | |
| | End of calendar | | | |
| | year | | | |
| May 31, 2006 | Scheduled | $975 | $975 | RMD for 2006 is $3,900. There are four quarterly |
| | withdrawal | | | payment dates left in the calendar year to satisfy |
| | | | | requirement. $3,900/4 = $975 |
| Jun. 15, 2006 | Contract | $5,000 | — | Account value increased to $65,000; increase is paid |
| | anniversary | | | to account owner; GWA remains at $3,000 |
| Jun. 31, 2006 | Scheduled | $975 | $975 | |
| | withdrawal | | | |
| Sep. 30, 2006 | Scheduled | $975 | $975 | |
| | withdrawal | | | |
| Dec. 31, 2006 | Scheduled | $975 | $975 | RMD for 2006 has been satisfied. |
| | withdrawal & | | | |
| | End of calendar | | | |
| | year | | | |

The account owner who elects option (vii) is thus able to receive payments of $5,000 more than the account owner utilizing a prior systematic withdrawal program. While Table 7 illustrates a situation where the account owner chooses to withdraw the full $5,000 “earnings” for the current account period and thereby maintain the guaranteed withdrawal amount constant into the next account period, option (vii) also encompasses situations where the account holder chooses to withdraw less than the full “earnings” (e.g., a percentage or dollar amount less than the full amount). According to such embodiments, the guaranteed withdrawal amount may well increase into the subsequent account period. It is also to be understood that the formula for calculating the guaranteed withdrawal amount may change from one account period to the next (e.g., as a result of an increase or decrease in the percentage applied to the benefit basis) so that even if the account owner withdraws the full “earnings”, the guaranteed withdrawal amount may well still increase into the next account period. Under such a scenario, the present invention encompasses embodiments where the adjustable amount exceeds the full “earnings” in order to maintain the guaranteed withdrawal amount constant into the next account period.

As discussed previously, each of these seven adjustable amount options may also be elected by the account owner for a limited or unlimited period of time, or may be elected in combination to apply over different periods of time.

### System Architecture

The following section describes some exemplary system architectures that could be used to practice the present invention. As mentioned previously, a system of the present invention may comprise one or more components and a computer program product that includes logic stored on a computer readable medium, wherein the logic includes instructions for instructing the one or more components of the system to perform a process of the present invention. It will be appreciated that these systems may be implemented using general purpose computers, servers, microprocessors, or the like that run the computer program product. The present invention encompasses any such processing device that has been modified to run a computer program product of the invention. In general, the computer program product can be implemented using any operating system, and associated hardware including, but not limited to, Unix, Linux, VMS, IBM, Microsoft Windows NT, 95, 98, 2000, ME, XP, Vista, Palm OS, Microsoft Windows CE and the like. Appropriate software coding for the logic stored on the computer program product can readily be prepared by skilled programmers based on the teachings herein, as will be apparent to those skilled in the relevant art(s). The present invention also encompasses computer program products that may be hosted on a storage medium and that include logic that can be used to program a processing device to perform a process in accordance with the present invention. The storage medium can include, but is not limited to, any type of disk including a floppy disk, optical disk, CDROM, magneto-optical disk, ROMs, RAMs, EPROMs, EEPROMs, flash memory, magnetic or optical cards, or any type of media suitable for storing electronic instructions, either locally or remotely. As would be evident to one skilled in the art, the results of the computations for implementing the processes of the present invention, such as account values, benefit basis, guaranteed withdrawal amounts, payment amounts and frequency, and other information regarding an account can be stored in memory and retrieved from memory as needed.

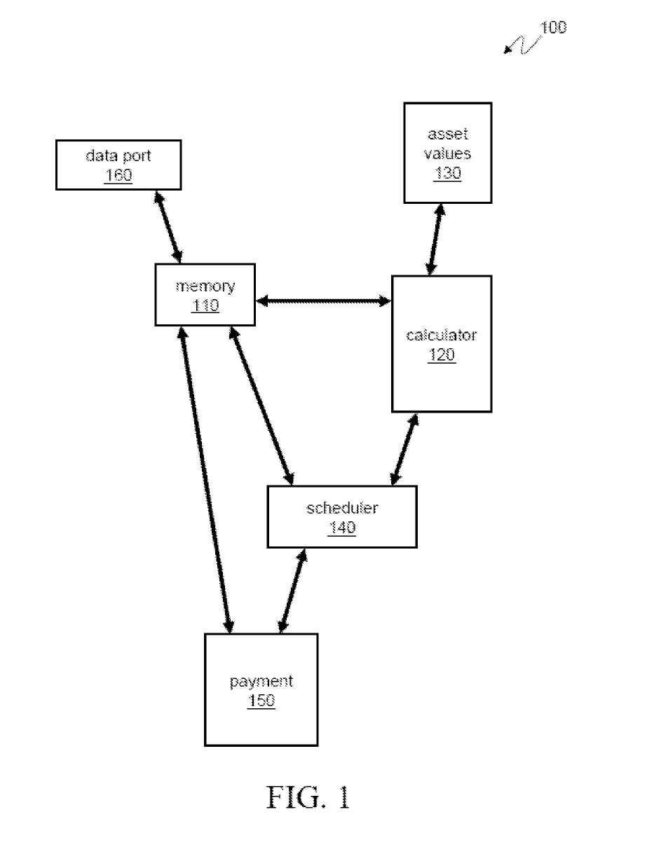

FIG. 1 is a functional block diagram of the architecture of an exemplary system 100 of the present invention. A memory component 110 stores information regarding an investment account for a particular account owner. For example, the memory component 110 may store the identity and age of the account owner, identification of the assets included in the account, the account value, the benefit basis, the guaranteed withdrawal amount, the adjustable amount option, the account period and/or anniversary, the desired frequency of withdrawals, a history of deposits and/or withdrawals, etc. It is to be understood that the memory component 110 may comprise a collection of sub-memory components that store different items of information associated with the account and that these may be located on the same device or devices that are in communication with one another, e.g., within a single processing device or via a network. We use the term “network” to encompass a Local Area Network (LAN), Wide Area Network (WAN) or the Internet that can interface with one or more devices via connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. In particular, memory component 110 may include one or more data storage components (e.g., a storage area network or SAN, a network attached storage or NAS, or a SAN-NAS hybrid) in communication with one or more short term memory components. For example, the data storage components could be used to store the account information on a long term basis while the short term memory component(s) are used temporarily to store account information as it gets communicated from the data storage component(s) to other components within the system.

As shown in FIG. 1, memory component 110 is in communication with calculator component 120 that determines the current account value, via access to a source of current asset values 130. These current asset values 130 may be locally available, or may be obtained by accessing one or more remote sites via a network (e.g., the Internet, an intranet, or private access site or system that contains the current value of assets listed on one or more stock exchanges). In certain embodiments, the calculator component 120 recalculates the current value of the assets to determine an account value on a daily basis. Calculator component 120 then stores the new account value on memory component 110. In certain embodiments, calculator component 120 is also used by the system to calculate and thereby adjust the benefit basis, the guaranteed withdrawal amount and/or the payment amount when needed (e.g., after a deposit, after an unscheduled withdrawal, after a bonus, after a step up, at the end or beginning of an account period and/or before a scheduled withdrawal). It will be appreciated that the present invention also encompasses systems that use different calculators to perform different calculations. It is also to be understood that any value used herein can be determined using one or more look up tables (e.g., a look up table stored on memory component 110) instead of by calculation.

In certain embodiments, the calculator component 120 may need to access additional information in order to perform a calculation. For example, under options (v), (vi) and (vii) the calculator component 120 needs to know the required minimal distribution (RMD) applicable for the current calendar year based on the age of the account owner. In certain embodiments, this information might be locally available (e.g., stored on memory component 110 in the form of a look up table). In other embodiments the calculator may retrieve the RMD by accessing one or more remote sites via a network (e.g., the Internet or an intranet). Similarly, under certain embodiments of option (iii), the calculator component 120 may need to access a publicly-available financial index (e.g., a consumer price index) in order to determine the variable percentage to apply when calculating the guaranteed withdrawal amount for the current account period. Typically this information is retrieved by accessing a remote site via a network.

In certain embodiments, the system also includes a scheduler component 140 in communication with the memory component 110 and calculator component 120. According to such embodiments, scheduler component 140 periodically (e.g., daily, weekly, monthly, quarterly, etc.) queries memory component 110 to determine whether the account has reached the end or beginning of an account period and/or to determine whether a periodic payment is due. For example, if scheduler component 140 determines that the account has reached the end of an account period it may instruct calculator component 120 to calculate the guaranteed withdrawal amount for the subsequent account period which adjusted amount is then optionally converted into periodic payment amounts and stored on memory component 110. Alternatively, scheduler component 140 may determine that a periodic payment is due and therefore instructs a payment component 150 to administer a payment to the account owner. Payment component 150 may in turn query memory component 110 to determine the payment amount and/or details of how the payment should be made.

In general it is to be understood that system 100 may be embodied as a combination of hardware and software elements, and may be configured as a stand-alone system or as a distributed system, or any combination in between. Each of the aforementioned components of the system can be considered elements of a processor, or software modules, that are associated with the system 100, but need not be collocated, nor exclusive to the processing system 100. For example, the payment component 150 may include a third party service for actually distributing the payments. Similarly, as mentioned above, some or all of the components of the system 100 may be located on a network, including the Internet.

In certain embodiments, the account owner may be provided on-line access to one or more items of account information stored on memory component 110 (e.g., identification of the assets included in the account, the account value, the benefit basis, the guaranteed withdrawal amount, the adjustable amount option, the account period and/or anniversary, the desired frequency of withdrawals, a history of deposits and/or withdrawals, etc.) so that he or she can monitor his or her account. In certain embodiments, the system 100 may also provide the account owner with options for modifying the account, e.g., for changing the adjustable amount option, for changing the frequency of payments, etc. In particular, the system 100 may allow the account owner (or agent) to initiate automatic withdrawals based on one of the adjustable amount options via on-line access. In general, the system 100 may include a data port 160 that enables information about the account (e.g., the adjustable amount option that was chosen by, or on behalf of, the account owner, the payment frequency, etc.) to be communicated to memory component 110 for storage. For example, in certain embodiments, such information may be received orally (e.g., by telephone) or on a physical medium such as paper (e.g., by mail or facsimile). In such embodiments, the information may be manually entered via the data port 160 (e.g., by an individual using a keyboard or other mechanical input device) or could be automatically read into the memory component (e.g., using a scanning device or other optical input device). In certain embodiments, information regarding the chosen option (whether an initial request to initiate automatic withdrawals based on an inventive option or to adjust a previous request) may be received electronically, e.g., via the Internet as discussed above.

### Other Embodiments

Other embodiments of the invention will be apparent to those skilled in the art from a consideration of the specification or practice of the invention disclosed herein. It is intended that the specification and examples be considered as exemplary only.

We claim:

1. A system comprising one or more components and a computer program product that includes logic stored on a computer readable medium, wherein the logic includes instructions for instructing the one or more components of the system to perform a process for administering withdrawals from an investment account that has a withdrawal option and a guaranteed withdrawal amount that can be withdrawn each account period, wherein the process comprises steps of:
(a) receiving a request from, or on behalf of, an account owner to withdraw automatically, from the investment account, an adjustable amount selected from the group consisting of:
(i) the guaranteed withdrawal amount each account period;
(ii) a fixed percentage of the guaranteed withdrawal amount each account period;
(iii) a variable percentage of the guaranteed withdrawal amount each account period;
(iv) the guaranteed withdrawal amount each account period plus an amount before the end of each account period such that the guaranteed withdrawal amount does not decrease at the beginning of the subsequent account period;
(v) the guaranteed withdrawal amount each account period plus an additional amount before the end of a calendar year if needed to satisfy a required minimum distribution;
(vi) an amount sufficient to satisfy a required minimum distribution over a calendar year plus an additional amount before the end of each account period if needed to fully consume the guaranteed withdrawal amount; and
(vii) an amount sufficient to satisfy a required minimum distribution over a calendar year plus an amount at the end of each account period such that the guaranteed withdrawal amount does not decrease at the beginning of the subsequent account period; and
(b) storing data associated with the account owner's request.

2. The system of claim 1, wherein the process further comprises:
determining the adjustable amount that will satisfy the account owner's request for a current account period; and
administering any necessary withdrawals for the current account period.

3. The system of claim 2, wherein the process further comprises:
determining the adjustable amount that will satisfy the account owner's request for a subsequent account period; and
administering any necessary withdrawals for the subsequent account period.

4. The system of claim 1, wherein the account has a benefit basis and the guaranteed withdrawal amount for an account period is a percentage of the benefit basis during the account period.

5. The system of claim 4, wherein the benefit basis increases from one account period to the next or the benefit basis increases during an account period.

6. The system of claim 4, wherein the percentage applied to the benefit basis changes from one account period to the next or during an account period.

7. The system of claim 1, wherein the adjustable amount requested is the guaranteed withdrawal amount each account period.

8. The system of claim 1, wherein the adjustable amount requested is a fixed percentage of the guaranteed withdrawal amount each account period.

9. The system of claim 1, wherein the adjustable amount requested is a variable percentage of the guaranteed withdrawal amount each account period.

10. The system of claim 1, wherein the adjustable amount requested is the guaranteed withdrawal amount each account period plus an amount before the end of each account period such that the guaranteed withdrawal amount does not decrease at the beginning of each subsequent account period.

11. The system of claim 1, wherein the adjustable amount requested is the guaranteed withdrawal amount each account period plus an additional amount before the end of a calendar year if needed to satisfy a required minimum distribution.

12. The system of claim 1, wherein the adjustable amount requested is an amount sufficient to satisfy a required minimum distribution over a calendar year plus an additional amount before the end of each account period if needed to fully consume the guaranteed withdrawal amount.

13. The system of claim 1, wherein the adjustable amount requested is an amount sufficient to satisfy a required minimum distribution over a calendar year plus an amount at the end of each account period such that the guaranteed withdrawal amount does not decrease at the beginning of the subsequent account period.

14. A computer program product that includes logic stored on a computer readable medium, wherein the logic includes instructions for instructing one or more components of a system to perform a process for administering withdrawals from an investment account that has a withdrawal option and a guaranteed withdrawal amount that can be withdrawn each account period, wherein the process comprises steps of:
(a) receiving a request from, or on behalf of, an account owner to withdraw automatically, from the investment account, an adjustable amount selected from the group consisting of:
(i) the guaranteed withdrawal amount each account period;
(ii) a fixed percentage of the guaranteed withdrawal amount each account period;
(iii) a variable percentage of the guaranteed withdrawal amount each account period;
(iv) the guaranteed withdrawal amount each account period plus an amount before the end of each account period such that the guaranteed withdrawal amount does not decrease at the beginning of the subsequent account period;
(v) the guaranteed withdrawal amount each account period plus an additional amount before the end of a calendar year if needed to satisfy a required minimum distribution;
(vi) an amount sufficient to satisfy a required minimum distribution over a calendar year plus an additional amount before the end of each account period if needed to fully consume the guaranteed withdrawal amount; and
(vii) an amount sufficient to satisfy a required minimum distribution over a calendar year plus an amount at the end of each account period such that the guaranteed withdrawal amount does not decrease at the beginning of the subsequent account period; and
(b) storing data associated with the account owner's request.

15. The product of claim 14, wherein the process further comprises:
determining the adjustable amount that will satisfy the account owner's request for a current account period; and
administering any necessary withdrawals for the current account period.

16. The product of claim 15, wherein the process further comprises:
determining the adjustable amount that will satisfy the account owner's request for a subsequent account period; and
administering any necessary withdrawals for the subsequent account period.

17. The product of claim 14, wherein the account has a benefit basis and the guaranteed withdrawal amount for an account period is a percentage of the benefit basis during the account period.

18. The product of claim 17, wherein the benefit basis increases from one account period to the next or the benefit basis increases during an account period.

19. The product of claim 17, wherein the percentage applied to the benefit basis changes from one account period to the next or during an account period.

20. The product of claim 14, wherein the adjustable amount requested is the guaranteed withdrawal amount each account period.

21. The product of claim 14, wherein the adjustable amount requested is a fixed percentage of the guaranteed withdrawal amount each account period.

22. The product of claim 14, wherein the adjustable amount requested is a variable percentage of the guaranteed withdrawal amount each account period.

23. The product of claim 14, wherein the adjustable amount requested is the guaranteed withdrawal amount each account period plus an amount before the end of each account period such that the guaranteed withdrawal amount does not decrease at the beginning of each subsequent account period.

24. The product of claim 14, wherein the adjustable amount requested is the guaranteed withdrawal amount each account period plus an additional amount before the end of a calendar year if needed to satisfy a required minimum distribution.

25. The product of claim 14, wherein the adjustable amount requested is an amount sufficient to satisfy a required minimum distribution over a calendar year plus an additional amount before the end of each account period if needed to fully consume the guaranteed withdrawal amount.

26. The product of claim 14, wherein the adjustable amount requested is an amount sufficient to satisfy a required minimum distribution over a calendar year plus an amount at the end of each account period such that the guaranteed withdrawal amount does not decrease at the beginning of the subsequent account period.

27. A process for administering withdrawals from an investment account that has a withdrawal option and a guaranteed withdrawal amount that can be withdrawn each account period, wherein the process comprises steps of:
(a) receiving a request from, or on behalf of, an account owner to withdraw automatically, from the investment account, an adjustable amount selected from the group consisting of:
(i) the guaranteed withdrawal amount each account period;
(ii) a fixed percentage of the guaranteed withdrawal amount each account period;
(iii) a variable percentage of the guaranteed withdrawal amount each account period;
(iv) the guaranteed withdrawal amount each account period plus an amount before the end of each account period such that the guaranteed withdrawal amount does not decrease at the beginning of the subsequent account period;
(v) the guaranteed withdrawal amount each account period plus an additional amount before the end of a calendar year if needed to satisfy a required minimum distribution;
(vi) an amount sufficient to satisfy a required minimum distribution over a calendar year plus an additional amount before the end of each account period if needed to fully consume the guaranteed withdrawal amount; and
(vii) an amount sufficient to satisfy a required minimum distribution over a calendar year plus an amount at the end of each account period such that the guaranteed withdrawal amount does not decrease at the beginning of the subsequent account period; and
(b) storing data associated with the account owner's request.

28. The process of claim 27, wherein the process further comprises:
determining the adjustable amount that will satisfy the account owner's request for a current account period; and
administering any necessary withdrawals for the current account period.

29. The process of claim 28, wherein the process further comprises:
determining the adjustable amount that will satisfy the account owner's request for a subsequent account period; and
administering any necessary withdrawals for the subsequent account period.

30. The process of claim 27, wherein the account has a benefit basis and the guaranteed withdrawal amount for an account period is a percentage of the benefit basis during the account period.

31. The process of claim 30, wherein the benefit basis increases from one account period to the next or the benefit basis increases during an account period.

32. The process of claim 30, wherein the percentage applied to the benefit basis changes from one account period to the next or during an account period.

33. The process of claim 27, wherein the adjustable amount requested is the guaranteed withdrawal amount each account period.

34. The process of claim 27, wherein the adjustable amount requested is a fixed percentage of the guaranteed withdrawal amount each account period.

35. The process of claim 27, wherein the adjustable amount requested is a variable percentage of the guaranteed withdrawal amount each account period.

36. The process of claim 27, wherein the adjustable amount requested is the guaranteed withdrawal amount each account period plus an amount before the end of each account period such that the guaranteed withdrawal amount does not decrease at the beginning of each subsequent account period.

37. The process of claim 27, wherein the adjustable amount requested is the guaranteed withdrawal amount each account period plus an additional amount before the end of a calendar year if needed to satisfy a required minimum distribution.

38. The process of claim 27, wherein the adjustable amount requested is an amount sufficient to satisfy a required minimum distribution over a calendar year plus an additional amount before the end of each account period if needed to fully consume the guaranteed withdrawal amount.

39. The process of claim 27, wherein the adjustable amount requested is an amount sufficient to satisfy a required minimum distribution over a calendar year plus an amount at the end of each account period such that the guaranteed withdrawal amount does not decrease at the beginning of the subsequent account period.
